(19) United States
(12) Patent Application Publication
(10) Pub. No.: US 2025/0183973 A1
(43) Pub. Date: Jun. 5, 2025

(54) PRECODING FOR BEAMFORMING

(71) Applicant: BRITISH TELECOMMUNICATIONS PUBLIC LIMITED COMPANY, London, Greater London (GB)

(72) Inventors: Yangyishi ZHANG, London, Greater London (GB); Anas AL RAWI, London, Greater London (GB)

(21) Appl. No.: 18/844,282

(22) PCT Filed: Feb. 16, 2023
(86) PCT No.: PCT/EP2023/053969

§ 371 Date: Sep. 5, 2024

(30) Foreign Application Priority Data
Mar. 11, 2022 (GB) 2203385.6

(51) Int. Cl. H04B 7/06; H04B 7/0456; H04L 25/02

(52) U.S. Cl. CPC H04B 7/0634; H04B 7/0456; H04L 25/0244

(57) ABSTRACT

A computer-implemented method for determining a transmit precoding operation to apply to a signal to be transmitted through a wireless channel via beamforming wherein the signal u is represented by a vector, u, is described. The method comprises obtaining an inverse channel matrix, G wherein the inverse channel matrix, G, is an inverse of a channel matrix, H, wherein the channel matrix, H, is a matrix representation of the wireless channel. The method further comprises determining a vector, b, that approximately minimizes a square of a norm of a result of applying the inverse channel matrix G to the sum of the vector representing the signal, u, and the vector, b, wherein the entries of the vector, b, are integers and determining the vector b.

The present disclosure relates to a more efficient method for determining a transmit precoding operation to apply to a signal that is going to be transmitted through a wireless channel via beamforming.

### BACKGROUND

Beamforming involves focusing a wireless signal towards a specific receiving device rather than having the signal spread in all directions from the transmitter. One of the challenges in multiple-input multiple-output (MIMO) beamforming is to correct for phase and amplitude errors caused by transmitting signals through coupled wireless channels. One technique to correct for these errors involves characterising the phase and amplitude errors as a channel matrix, H, and applying an inverse of the matrix, G, to the signals before sending them through the channels. However, the channel matrix, H, generally characterises loss and so the elements of H are small. This results in the elements of the inverse channel matrix, G, being large. The application of the inverse channel matrix, G, to the signal thus amplifies the signal. However, regulatory power limits mean there is a limit to the power of the signal that can be transmitted. In addition, transmitting high power signals can be costly. Therefore, it can become necessary to decrease the amplitude of the signal after the application of G by dividing the signal by a factor prior to transmission. This needs to be compensated for at the receiver end by amplification of the received signal e.g. multiplication of the signal by the factor. However, this then results in the amplification of any noise acquired in the channel.

In order to reduce this issue, previous systems have considered applying a transmit precoding operation before the application of inverse channel matrix, G. This transmit precoding operation is selected to reduce the amplification that results from applying G to the signal while also being easy to correct for on the receiver end. However, prior art techniques of selecting a precoding operation either perform poorly or incur too much processing delay. It is therefore desirable to provide an improved technique for determining a precoding to apply to a signal before transmission via beamforming.

The examples described herein are not limited to examples which solve problems mentioned in this background section.

### SUMMARY

Examples of preferred aspects and embodiments of the invention are as set out in the accompanying independent and dependent claims.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

This application relates to a computer-implemented method for determining a transmit precoding operation to apply to a signal to be transmitted through a wireless channel via beamforming where the signal u is represented by a vector, u. The method comprises obtaining an inverse channel matrix, G wherein the inverse channel matrix, G, is an inverse of a channel matrix, H, wherein the channel matrix, H, is a matrix representation of the wireless channel. The method further comprises determining a vector, b, that approximately minimizes a square of a norm of a result of applying the inverse channel matrix G to the sum of the vector representing the signal, u, and the vector, b, wherein the entries of the vector, b, are integers. Determining the vector b, comprises: obtaining an initial estimate for the vector, b; cloning the initial estimate of the vector, b, n times; and providing a clone of the initial estimate of the vector b to each of n independent processing runs as a current estimate for the vector, b. Determining the vector b, further comprises for each of the n independent processing runs, setting a counter to an initial value, and then iteratively performing the following iteration steps: producing two copies of the current estimate for the vector, b; applying a randomly generated mutation vector to each of the two copies of the current estimate of the vector, b, wherein the randomly generated mutation vector is generated separately for each copy of the current estimate of the vector, b; calculating a value of a cost function for the current estimate of the vector, b, and the two mutated copies of the current estimate of the vector, b; selecting the estimate of the vector b that has a best value of the cost function wherein the selection is from the two mutated copies of the current estimate of the vector, b, and the current estimate of the vector b; and in response to the selected estimate being one of the mutated copies of the current estimate of the vector, b, replacing the current estimate of the vector, b, with the mutated copy of the current estimate of the vector, b, that resulted in the best value of the cost function; or in response to the selected estimate being the current estimate of the vector, b, maintaining the current estimate of the vector, b; and comparing the best value of the cost function with a best value of the cost function from the previous iteration. The iteration steps further comprise in response to the best value of the cost function being better than the best value of the cost function from the previous iteration: resetting the counter to the initial value; and performing another iteration of the iteration steps; or in response to the best value of the cost function being the same as the best value of the cost function from the previous iteration: incrementing the value of the counter; determining if the counter has reached a threshold value; and in response to the counter not having reached the threshold value performing another iteration of the iteration steps; or in response to the counter having reached the threshold value, returning the current estimate of the vector, b, as the processing run estimate of the vector b. Once at least one the processing runs has returned a processing run estimate of the vector b, the method comprises obtaining a value of the cost function for each processing run estimate of the vector, b; and selecting as the vector, b, the processing run estimate of the vector b with the best value of the cost function.

The skilled person would understand that having a step performed in response to a condition can mean the step being performed if the condition is satisfied.

When H is a square matrix then G can be an inverse of H calculated in any known way. When H is not a square matrix then a Moore-Penrose pseudo inverse can be used to determine the inverse channel matrix, G.

The previous iteration may be the iteration immediately prior to the current iteration i.e. the iteration before the current/present iteration. In the case of the first iteration, the best value of the cost function from the previous iteration may correspond to the cost function for the initial estimate of the vector, b.

The above method provides an improved way of determining an estimate of the vector b that can be used for precoding. In particular the above method provides a technique for estimating the vector b where the best-case complexity is lower than in the prior art and the convergence to an optimal solution is faster than in the prior art. In addition, the above method can fully utilize parallel computing in a way prior art methods cannot.

In some examples of the above method once one processing run has returned a processing run estimate all other processing runs are terminated. The current best estimate of the vector b for each of the terminated processing runs is then used as a processing run estimate of the vector b for the respective processing run. In other examples, all processing runs perform iterations until their counter reaches a threshold value. In further examples, m out of the n processing runs may be required to complete and all other processing runs may be terminated when the m processing runs have complete. The terminated processing runs may then provide their current best estimate of the vector b as their processing run estimate of the vector b.

In some examples the method further comprises applying the transmit precoding operation to the signal by adding the vector b to the vector representation of the signal, u, to obtain a pre-coded signal, applying the inverse channel matrix, G, to the pre-coded signal to obtain a corrected signal, and transmitting the corrected signal through the wireless channel. Thus, the method can further comprise performing processing using the determined transmit precoding to transmit a signal, for example, via beamforming.

The method may also further comprise receiving the transmitted corrected signal, and applying a modulo function to each entry of the vector representing the transmitted corrected signal wherein the modulo function keeps both the sign and fractional part of its input value. As such, the method may cover both the actions performed by the transmitter and the actions performed by the receiver.

In some examples determining a vector, b, that approximately minimizes the square of the norm of the value obtained when applying the inverse channel matrix G to the sum of the vector representing the signal, u, and the vector, b, comprises determining a vector, b, that approximately minimizes the function ∥−Gu−Gb∥². The function ∥−Gu−Gb∥² provides a way of estimating the square of the norm of the value obtained when applying the inverse channel matrix G to the sum of the vector representing the signal, u and the vector, b.

In some examples the cost function comprises a square of a norm of a result of applying the inverse channel matrix G to the sum of the vector representation of the signal, u, and the estimate of the vector, b. The cost function can therefore be a representation of the value to be minimized. The best value of the cost function may therefore be the lowest value of the cost function. This provides a suitable cost function for determining which value of the vector b comes closest to minimizing the square of the norm of the value obtained when applying the inverse channel matrix G to the sum of the vector representing the signal, u and the vector, b.

In some examples obtaining an initial estimate of the vector, b, comprises performing lattice reduction on the inverse channel matrix, G, to obtain a reduced inverse channel matrix Gᵢ and a unimodular transformation T, obtaining an initial estimate of the vector, b, using Babai's rounding off technique and the unimodular transformation, T, and transforming the obtained initial estimate of the vector, b, into the reduced lattice basis. Transforming the obtained initial estimate of the vector, b, into the reduced lattice basis may comprise applying an inverse of the unimodular transform to the initial estimate of the vector, b. For example if the initial estimate of the vector b in the reduced basis is given by lᵢ and in the original basis by bᵢ then lᵢ=T⁻¹bᵢ. The use of lattice reduction means the search for the vector b can occur in a gradient descent style meaning the search may converge faster than prior art techniques. If the unimodular transform, T, is a square matrix, then the inverse of the unimodular transform, T⁻¹, can be calculated in any known way. When T is a rectangular matrix, then a Moore-Penrose pseudo inverse can be used to calculate the inverse of T.

In some examples performing lattice reduction on the inverse channel matrix, G comprises using a Lenstra-Lenstra-Lovász algorithm to obtain the reduced inverse channel matrix Gᵢ and the unimodular transformation T. The Lenstra-Lenstra-Lovász algorithm provides a relatively efficient technique for performing lattice reduction that provides a reasonable initial estimate of the vector b.

In some examples when the estimate of the vector, b, is in the reduced lattice basis the cost function comprises ∥G(u+Tlₑ)∥² wherein lₑ. is the estimate of the vector b in the reduced lattice basis. Therefore, the estimate of the vector b is transformed back to the original basis before being used in the cost function. An estimate of the vector b will be in the reduced lattice basis if the initial estimate of the vector b was transformed to the reduced lattice basis and has not been transformed back before the estimate is generated. The above cost function provides a cost function that can be used without transforming the vectors being copied/cloned.

In some examples in response to the current estimate of the vector, b, and at least one of the two mutated copies of the estimate of the vector, b, both having the best value of the cost function, the method further comprises selecting the current estimate of the vector, b, as having the best value of the cost function. This ensures the counter is only incremented when the current estimate of the vector, b is not replaced.

In some examples in response to both of the mutated copies of the estimate of the vector, b, having the best value of the cost function, the method further comprises randomly selecting one of the mutated copies as having the best value of the cost function. In other examples, in response to both of the mutated copies of the estimate of the vector, b, having the best value of the cost function, the method further comprises selecting the first generated mutated copy as having the best value of the cost function. These two examples may require the current estimate of the vector b has a value of the cost function worse that the best value of the cost function. This ensures the method selects a single estimate of the vector b to be the current estimate of the vector b at each iteration even if both mutated copies have the best value of the cost function.

In some examples, the method further comprises for the first iteration randomly generating the mutation vectors such that all elements of each mutation vector are susceptible to applying a mutation to a copy of the current estimate of the vector, b, and each element of each mutation vector applies a mutation to the copy of the current estimate of the vector, b, with probability, P. The method then comprises in response to the best value of the cost function being the same as the best value of the cost function from the previous iteration decreasing the number of elements of the mutation vector that are susceptible to applying a mutation to a copy of the current estimate of the vector, b in the next iteration, and increasing the probability of each susceptible element of the mutation vector applying a mutation to the copy of the current estimate of the vector, b in the next iteration. In relation to the first iteration, the best value of the cost function can be considered to be the same as the best value of the cost function from the previous iteration if the initial estimate of the vector b has the best value of the cost function. The changing of the probability and susceptibility of applying a mutation results in a form of annealing which can improve the final estimate of the vector, b.

In some examples, in response to the best value of the cost function being better than the best value of the cost function from the previous iteration, the method further comprises in the next iteration maintaining the number of elements of the mutation vector that are susceptible to applying a mutation as the number of elements of the mutation vector that were susceptible to applying a mutation in the current iteration, and in the next iteration maintaining the probability of each susceptible element of the mutation vector applying a mutation as the probability of each susceptible element of the mutation vector applying a mutation from the current iteration. This provides a limit to the annealing and aids in finding the best possible estimate of the vector b.

In some examples the initial value of the counter is gᵢₙₜ and the threshold value of the counter is gₘₐₓ. The method then comprises in response to the best value of the cost function being the same as the best value of the cost function from the previous iteration increasing the probability of each susceptible element of the mutation vector applying a mutation in the next iteration to

$${P}_{n} = {P}_{p}^{R} \sqrt{\frac{1}{{P}_{p}}}$$

wherein Pₚ is the probability of each susceptible element of the mutation vector applying a mutation in the current iteration, and

$$R = \frac{{g}_{max} - {g}_{int}}{2} .$$

The method also comprises decreasing the number of elements of the mutation vector that are susceptible to applying a mutation in the next iteration to

$${N}_{n} = {N}_{p}^{R} \sqrt{\frac{1}{K}}$$

wherein Nₚ is the number of elements susceptible to applying a mutation in the current iteration and K is the number of elements of the mutation vector. The above provides a particularly useful example of annealing that aids in finding a best estimate of the vector, b.

The present application also relates to an apparatus for determining a transmit precoding operation to apply to a signal be transmitted through a wireless channel via beamforming wherein the signal u is represented by a vector, u, the apparatus comprising: a processor; and a memory, the memory containing computer-readable instructions that when executed by the processor cause the processor to perform a method as described above.

The present application further relates to a non-transitory computer-readable storage medium containing computer-readable instructions that when executed by the processor cause the processor to perform a method as described above.

It will also be apparent to anyone of ordinary skill in the art, that some of the preferred features indicated above as preferable in the context of one of the aspects of the disclosed technology indicated may replace one or more preferred features of other ones of the preferred aspects of the disclosed technology. Such apparent combinations are not explicitly listed above under each such possible additional aspect for the sake of conciseness.

Other examples will become apparent from the following detailed description, which, when taken in conjunction with the drawings, illustrate by way of example the principles of the disclosed technology.

### BRIEF DESCRIPTION OF THE DRAWINGS

Embodiments of the invention will be described, by way of example, with reference to the following drawings, in which:

FIG. 1 shows a model of a system in which the precoding of the present application will be used;

FIGS. 2A and 2B show the closest lattice vector problem and the effect of lattice reduction;

FIG. 3 shows a process flow of a signal, u, that will undergo the precoding of the present application;

FIG. 4 is a flowchart showing a process for determining an appropriate precoding in accordance with the present application;

FIG. 5 is a flow diagram showing a cycle of the process for determining an appropriate precoding in accordance with the present application; and

FIG. 6 an exemplary computing-based device on which the method for determining an appropriate precoding may be implemented.

The accompanying drawings illustrate various examples. The skilled person will appreciate that the illustrated element boundaries (e.g., boxes, groups of boxes, or other shapes) in the drawings represent one example of the boundaries. It may be that in some examples, one element may be designed as multiple elements or that multiple elements may be designed as one element. Common reference numerals are used throughout the figures, where appropriate, to indicate similar features.

### DETAILED DESCRIPTION

The following description is made for the purpose of illustrating the general principles of the present technology and is not meant to limit the inventive concepts claimed herein. As will be apparent to anyone of ordinary skill in the art, one or more or all of the particular features described herein in the context of one embodiment are also present in some other embodiment(s) and/or can be used in combination with other described features in various possible combinations and permutations in some other embodiment(s).

This application relates to beamforming in multiple input multiple output (MIMO) systems. In particular, this application relates to an improved method for determining a precoding to apply during beamforming.

The methods described herein may be performed by software in machine readable form on a tangible storage medium e.g. in the form of a computer program comprising computer program code means adapted to perform all the steps of any of the methods described herein when the program is run on a computer and where the computer program may be embodied on a computer readable medium. Examples of tangible (or non-transitory) storage media include disks, thumb drives, memory cards etc and do not include propagated signals. The software can be suitable for execution on a parallel processor or a serial processor such that the method steps may be carried out in any suitable order, or simultaneously.

This acknowledges that firmware and software can be valuable, separately tradable commodities. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

The preferred features may be combined as appropriate, as would be apparent to a skilled person, and may be combined with any of the aspects of the invention.

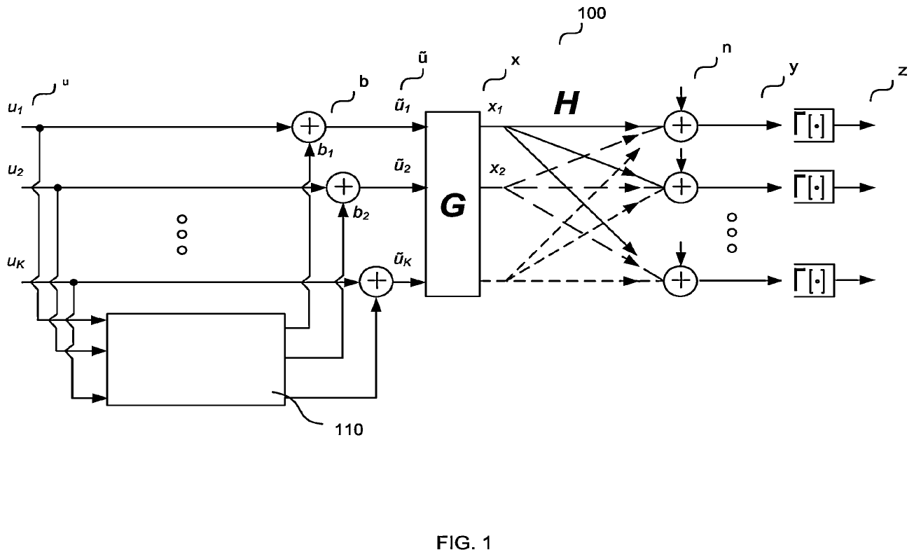

FIG. 1 shows a system model 100 in which the precoding will be used. In the model 100 a signal, u, is being transmitted via beamforming through a wireless channel that can take the form of a plurality of coupled wireless channels wherein the transmitter transmitting the signal has K antenna. The signal can be expressed as a vector u wherein

$$u = ( \begin{matrix}{u}_{1} \\ {u}_{2} \\ … \\ {u}_{K}\end{matrix} ) .$$

It is assumed that the signal vector consists of real-valued points uniformly distributed within the closed interval [−½,½]. When the signal is transmitted through the wireless channels the signal is subject to phase and amplitude errors. These errors can be expressed as a channel matrix, H, where H is a L×K matrix and L is the number of receivers. In some examples, the number of antennae may be the same as the number of receivers and the channel matrix H may be a K×K square matrix. In some examples, a 4×4 4-pulse amplitude modulated (4PAM) multiple-input multiple-output (MIMO) system may be used. However, other numbers of antenna and receiver are also possible. In order to reduce errors that come from transmitting the signal u through the wireless channel, before transmission an inverse channel matrix, G, is applied to the signal u to generate a corrected signal x wherein the corrected signal x is a vector

$$x = ( \begin{matrix}{x}_{1} \\ {x}_{2} \\ … \\ {x}_{3}\end{matrix} )$$

and G=H⁻¹. It is noted that if the channel matrix is square then the inverse channel matrix, G, can be an inverse of the channel matrix, H calculated in any known way. If the channel matrix, H, is rectangular then a Moore-Penrose pseudo inverse can be used to find the inverse channel matrix, G. The signal is then sent through the wireless channel where it is subject to the channel matrix, H, and noise, n, and received by the receiver as signal, y, in the form of vector

$$y = ( \begin{matrix}{y}_{1} \\ {y}_{2} \\ … \\ {y}_{K}\end{matrix} )$$

which can then be used to recover the original signal.

However, since the channel matrix H is lossy, the entries of the channel matrix H are small. This means that the inverse channel matrix, G, is large and applies an amplification to the signal, u. Regulatory power requirements limit the power of signals that can be transmitted. In addition, transmitting high power signals can be expensive and impractical. Therefore, in order to avoid transmitting a high-power signal the signal power is reduced before transmission by dividing the corrected signal x by a factor before transmission. When the signal y is received, this reduction can be compensated for by multiplying the received signal y by the factor. However, this also amplifies the noise, n, from the wireless channel which can make it harder to determine the original signal.

In order to overcome this it is desirable to apply a precoding operation, 110, by adding a vector b of the form

$$b = ( \begin{matrix}{b}_{1} \\ {b}_{2} \\ … \\ {b}_{K}\end{matrix} )$$

to the signal u to form pre-coded signal, ũ, before applying the matrix G to the signal u. It is noted that while here b is added to the signal, u, in other examples, b may be subtracted from the signal, u. In this case the cost functions would need to be adjusted accordingly. In order to enable the application of the precoding to be corrected for at a receiver without the receiver knowing the b chosen in advance, b is constrained such that the elements of the vector b are integers i.e. such that b∈ [symbol] ^{K}. Given the signal u consists of real-valued points uniformly distributed within the closed interval [−½,½], as discussed in more detail later, a receiver is able to separate the signal u from the precoding b, using a modulo operation. The vector b is chosen to try and minimize the square of the norm of G applied to pre-coded signal, u. In other words, the vector b is chosen to minimize a square of a norm of a result obtained when applying the inverse channel matrix, G to the sum of the vector representing the signal u and the vector b. This can be expressed mathematically as arg min∥Gu∥² and argmin∥−Gu−Gb∥² where b∈ [symbol] ^{K}.

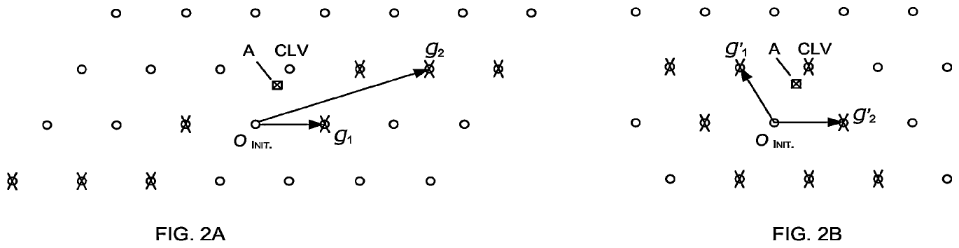

The minimization described above can be considered to be a closest lattice vector problem where 2A shows the initial lattice vector problem and 2B shows the lattice vector problem after lattice reduction. FIGS. 2A and 2B show a lattice of dots associated with the inverse channel matrix, G wherein G represents the basis of the lattice and the possible values for vector, b, the grid. The aim is to find the closest lattice vector, CLV, to a target, A, wherein the target A does not sit on one of the lattice vector points. When applied to precoding for beamforming, the target can be considered to be −Gu. In FIGS. 2A and 2B, the target, A, is represented as a square in the lattice vector points. The aim is to find the lattice vector point closest to the target A e.g. the lattice vector point that minimizes ∥−Gu−Gb∥². This problem is believed to be NP-hard and hence cannot be solved efficiently as the size of the system scales. As such, finding an exact solution is inefficient and results in significant processing delays which make this impractical. In addition, current methods for finding an approximate solution such as depth-first sphere encoding and K-best sphere encoding rely on a decision-feedback structure and the use of the Schnorr-Euchner method so can have a high best-case complexity and converge slowly. In addition, the asymptotic memory efficiency of the current scheme is higher as the memory size of depth-first sphere encoding and K-best sphere encoding tends to infinity. It is therefore desirable to provide an improved method for determining a vector, b, that approximately minimizes a square of a norm of a result obtained when applying the inverse channel matrix, G to the sum of the vector representing the signal u and the vector b. The skilled person would understand that the term “approximately minimizes” is used to represent the fact that the method does not always find an exact solution and so the solution found may be an approximate solution.

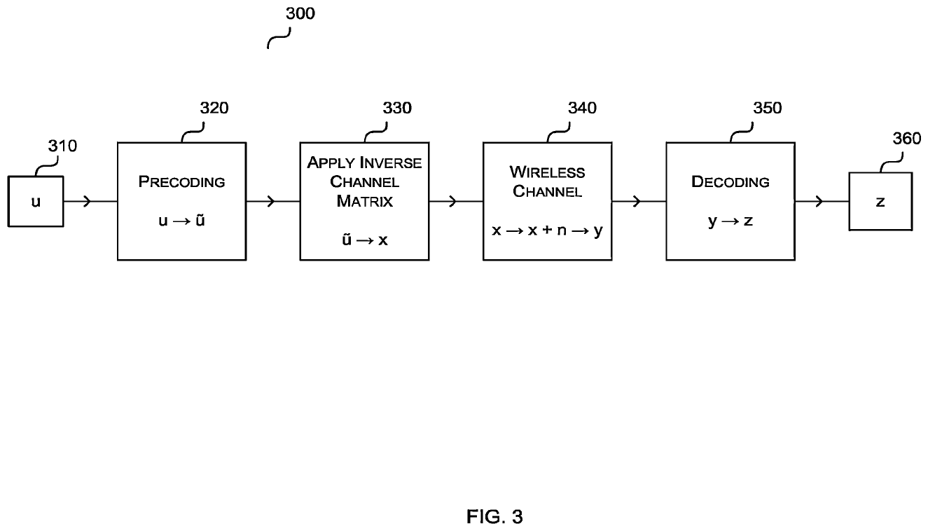

FIG. 3 shows an example system 300 in which precoding will be used. In box 310, a signal, u, to be sent to a client device via beamforming is determined/generated/received. The signal, u, represents data a user wishes to transmit to a receiving device wherein the receiving device may be an item of single-antenna user equipment (UE) such as a user mobile/cell phone, a computer, or a tablet, or a smart device such as a home smart device. The user data in the signal, u, can be any form of data the user wishes to transmit and may also be random data. The signal, u, will be sent to the receiving device via beamforming. Before the signal, u, is transmitted, a precoding operation 320, is applied to the signal u. This transforms the signal to form pre-coded signal, u. In order to reduce errors from the wireless channel, an inverse channel matrix 330 is applied to the pre-coded signal, ũ, to form a corrected signal, x. As mentioned above, if the channel matrix H is rectangular, this inverse channel matrix, G, may be a Moore-Penrose pseudo inverse of the channel matrix H. The corrected signal, x, is then transmitted through the wireless channel 340. In this step, the channel matrix, H is effectively applied to the corrected signal x by virtue of the signal passing through the channel. In addition, the corrected signal x, gains noise, n. Thus, the transmission of the correct signal x through the wireless channel results in an output signal, y, wherein y=Hx+n where n can be represented as a vector

$$n = ( \begin{matrix}{n}_{1} \\ {n}_{2} \\ ⋯ \\ {n}_{K}\end{matrix} ) .$$

The received signal, y, is decoded 350 using a modulo operation to remove the precoding 320. In some examples, the received signal, y is decoded 350 using Donald Knuth's rule adapted since the signal vector u consists of real-valued points uniformly distributed within the closed interval [−½,½], (rather than [0,1] for which Donald Knuth's rule is usually stated). The received signal, y, is thus decoded 350 to z using the rule

$$z = [ \begin{matrix}{y}_{1} - ⌊ {y}_{1} + 0.5 ⌋ \\ {y}_{2} - ⌊ {y}_{2} + 0.5 ⌋ \\ ⋯ \\ {y}_{k} - ⌊ {y}_{k} + 0.5 ⌋\end{matrix} ] .$$

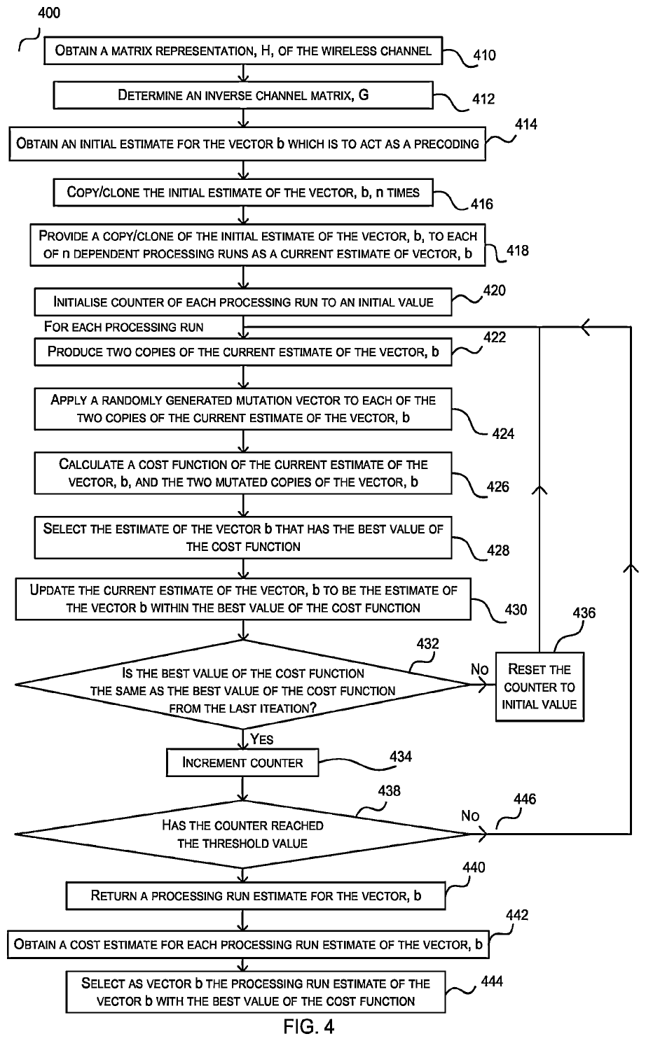

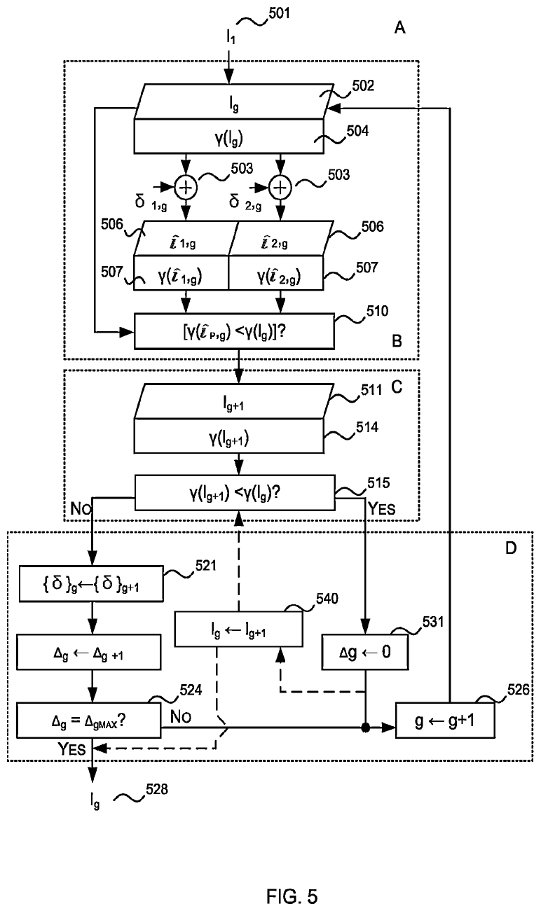

Turning now to FIGS. 4 and 5 a method 400 for determining a precoding vector, b, to apply to a signal, u is disclosed. While the precoding is designed to be used with beamforming and the process described above with respect to FIG. 3, the skilled person would understand that in some examples the precoding operations may be performed by a separate module before the application of the inverse channel matrix, G and the transmission of the signal. FIG. 4 is a flowchart showing all steps of determining a precoding while FIG. 5 is a flowchart detailing the steps performed by each processing run to estimate the vector, b.

As shown in item 410, the method 400 first comprises obtaining a matrix representation H of the wireless channel. The wireless channel is often, but not necessarily, air over which the signal u is being transmitted. Therefore, the wireless channel varies dependent upon the weather and other conditions of the air through which the signal u is being transmitted. For example, the variations can be time-variations due to the Doppler effect, frequency variations due to multi-path propagation and spatial variation due to location differences. The matrix representation of the wireless channel may therefore vary dependent upon weather and other factors. Determining the matrix representation of the wireless channel may thus involve using known channel estimation techniques. This can be done on the fly e.g. via pilot-assisted estimation. However, in other examples, occasionally, a matrix representation H of the wireless channel may be stored and accessed as necessary or provided by a third party.

Once the matrix representation H of the wireless channel has been determined, then the inverse channel matrix, G can be determined in step 412, wherein, if H is square, G=H⁻¹ and GH=I wherein/is the identity matrix. The inverse channel matrix, G can be determined by inverting the channel matrix, H, using any known technique. If the channel matrix, H is rectangular then the inverse channel matrix, G, may be a Moore-Penrose pseudo inverse of the channel matrix, H. In some examples, the inverse channel matrix, G may be obtained from a third party.

While the above example assumes that the channel matrix, H, and inverse channel matrix, G, need to be determined, the skilled person would understand that in other examples the inverse channel matrix, G, may be provided as an input to a method/system for determining the precoding operation. As such, the inverse channel matrix, G, could be supplied to or otherwise obtained by the precoding method/system without first determining or calculating G or H. For example, the inverse channel matrix, G, could be supplied by a third party or determined or supplied by another module of a larger system for beamforming.

Once the inverse channel matrix, G has been obtained then this can be used to determine a precoding 320 to apply to the signal u. The precoding takes the form of a vector, b, that is added to the signal, u, to form pre-coded signal u. Vector b is selected to approximately minimize the square of the norm of the result of applying inverse channel matrix G to the vector representation of the pre-coded signal u. In other words vector b is selected to approximately minimize the square of the norm of the result of applying the inverse channel matrix G to the sum of the vector representation of the signal u and the vector b. The term approximately minimized is used since an approximate rather than exact process to select vector b is used.

Determining the precoding 320 starts in step 414 where an initial estimate for the vector, b is determined. This initial estimate of the vector, b, can be determined in any known way. In one example lattice reduction is used wherein lattice reduction takes an integer lattice basis as input such as that shown in FIG. 2A and aims to find a basis with short nearly orthogonal vectors as shown in FIG. 2B. The Lenstra-Lenstra-Lovász (LLL) algorithm can be used to perform this lattice reduction. This results in a reduced inverse channel matrix G_{L} wherein det(G_{L})=det(G) but ∥G_{L}∥_{F}²≤∥G∥_{F}² wherein ∥·∥_{F} is the Frobenius norm. LLL algorithm produces a unimodular transform T where G=G_{L}T⁻¹. The unimodular transform, T, can then be used with Babai's rounding off technique to find the initial estimate, bᵣ₀, of the vector, b wherein bᵣₒ=−T┌T⁻¹u┘ wherein ┌·┘ represents a round-off operation to the nearest integer. If T is a square matrix, then the inverse of T, T⁻¹, can be calculated in any known way. When T is a rectangular matrix, then a Moore-Penrose pseudo inverse can be used to calculate the inverse of T. In other examples other lattice reduction algorithms can be used such as HKZ and Minkowski lattice reduction. As with the LLL lattice reduction, these algorithms return a unimodular transform, T, that can be used with Babai's rounding off technique to obtain an initial estimate, bᵣ₀, of the vector, b. If the inverse channel matrix, G, is not varying significantly with time, then the initial estimate does not need to be updated frequently and there is no need to perform lattice reduction, such as using the LLL algorithm regularly. However, if the inverse channel matrix, G is varying significantly with time, then lattice reduction may need to be performed regularly.

Once the initial estimate bᵣ₀ of the vector b has been obtained, this initial estimate is cloned/copied n times in step 416. The number n is determined based on the number of individual processing runs/steps/stages/units used. For example, n can be 15 when K=L=30. Other numbers of processing runs can also be used. In some examples, n is chosen to be greater than 1 to increase the probability of the optimal answer being found. However, in other examples only one processing run may be used. As discussed below, a copy of the initial estimate bᵣ₀ of the vector b, is supplied to each of the processing runs/steps/stages/units. Each processing run/step/stage/unit then processes its copy of the initial estimate bᵣ₀ of the vector b separately and independently from the other processing runs/steps/stages/units. This means there is no interaction between the processing runs/steps/stages/units until the processing runs/steps/stages/units produce their final result. This means there is no crossover between estimates of the vector, b. This lack of crossover can lead to better performance. In some examples, the processing runs/steps/stages/units can be performed in parallel. To this end, each processing run/step/stage/unit may be performed by separate processors, processing units or parts of a processor. The lack of crossover between estimates of the vector, b, enable this parallel implementation. However, in other example the processing runs/steps/stages/units may be performed sequentially either by the same or different processors and/or processing units. In addition, some processing runs/steps/stages/units may be performed in parallel and some sequentially. The skilled person would therefore understand that the term processing runs is not meant to imply the processing runs are sequential or the processing runs are performed by separate processors although both of these options are possible. Instead, the term processing run is used to describe a set of operations performed.

At step 418, a copy of the initial estimate bᵣ₀ of the vector b is supplied to each processing run. In this regard, the initial estimate bᵣ₀ of the vector b is referred to as a current estimate of the vector, b. Each processing run can start with the same initial estimate bᵣ₀ of the vector b e.g. the same initial current estimate of the vector, b. When the initial estimate of the vector, b was found using lattice reduction it is useful to exploit the reduced basis while determining the vector, b. To this end, the initial estimate bᵣ₀ of the vector b provided to each processing run may be in the reduced basis. As such the initial estimate provided can take the form lᵣ₀=T⁻¹bᵣ₀ and it is this value that is cloned/copied in the above step. As mentioned above, the processing runs can run sequentially, in parallel or in a combination of the two. Other than starting with the same initial estimate bᵣ₀ or lᵣ₀ of the vector b, the processing runs are independent as there is no cross-over between the results of each processing run.

The above steps can be considered to be initialisation and are performed in step A of FIG. 5 e.g. before the steps performed by each processing run. The provision of an initial estimate bᵣ₀ or lᵣₒ of the vector b to each processing run is shown in 501 of FIG. 5 and is represented by the input l₁. The initial estimate bᵣ₀ or lᵣ₀ of the vector b can be considered a current estimate of the vector b as shown in 502 of FIG. 5.

Each processing run now operates independently and completes the same set of operations. At step 420, each processing run initializes its counter to an initial value. In some examples, the initial value may be zero. In other examples the initial value may be one. However, the skilled person would understand that many initial values of the counter would be suitable provided is the initial value is known. The steps for each processing run described below are then repeated until the counter reaches a fixed value referred to as a threshold value. These steps can thus be called iteration steps. Iteration steps can include steps 422 to 438 of the method in FIG. 4.

At step 422, each processing run produces two copies/clones of the current estimate of the vector, b.

At step 424, a randomly generated mutation vector is applied to each of the two copies of the current estimate of the vector, b. The randomly generated mutation vectors applied to each copy of the current estimate of the vector b are generated independently but under the same mutation rules. This ensures that each copy of the current estimate of the vector, b, mutates independently. A mutation vector can be applied to a copy of the current estimate of the vector, b, by adding the mutation vector to the copy of the current estimate of the vector, b. The mutation vector can have elements that are −1, 0, or 1 wherein an element of −1 or 1 applies at mutation to the corresponding element of the copy of the current estimate of the vector, b and an element of 0 does not apply a mutation to the corresponding element of the copy of the current estimate of the vector, b. The mutation vector is randomly generated such that it has a probability, p, of applying a mutation to each individual element of the copy of the current estimate of the vector, b. Each element of the mutation vector is thus one of −1 or 1 with a probability p and is 0 with a probability 1-p. In some examples the probability of the mutation vector having element −1 and 1 is the same. Therefore, the probability of an element −1 is p/2, the probability of an element 0 is 1-p and the probability of an element 1 is p/2. In some examples, as described below, the probability of the randomly generated mutation vector applying a mutation to an individual element of the copy of the current estimate of the vector, b adapts based on the value of the counter and/or the number of iterations of the process run. This represents a form of annealing. However, in other examples, the probability of the randomly generated mutation vector applying a mutation to an individual element of the copy of the current estimate of the vector, b can remain the same throughout. For example, the randomly generated mutation vector can have a probability, p, of applying a mutation to an element of the current estimate of the vector, b where p is the same for all elements. In these cases p can be between 0.5 and 0.6 although other values of p are possible.

In FIG. 5, steps 422 and 424 are shown together as item 503 where two copies/clones of the current estimate of the vector b, l_{g} are produced. The first copy/clone of the current estimate of the vector, b, is subject to the mutation vector δ_{1,g} and the second copy/clone of the current estimate of the vector, b, is subject to the mutation vector δ_{2,g}. The clone/copy being subject to the mutation vector can be considered to be the application of a vector sum of the mutation vector to the clone/copy of the vector, b.

At step 426, a cost function is calculated for the current estimate of the vector, b and the two mutated copies of the vector, b. The cost function is a measure of how successfully the vector, b minimizes the square of the norm of the application of the inverse channel matrix G applied to the sum of the vector representing the signal, u, and the relevant (e.g. current/mutated) estimate of the vector, b. In some examples, this value can itself be used as the cost function i.e. the cost function is the square of the norm of the application of the inverse channel matrix G to the sum of the vector representing the signal, u and the relevant estimate of the vector, b. The cost function, γ, can therefore be γ=∥G (u+bₑ)∥² where be is the estimate of the vector b for which the cost function is being calculated. The cost function can also be expressed as γ=∥−Gu−Gbₑ∥². In other examples as the initial estimate of the vector b is in the reduced basis, the cost function can take the form γ=∥G(u+Tlₑ)∥² where lₑ is the current estimate of the vector b in the reduced basis (e.g. derived from lᵣ₀). The skilled person would understand that other cost functions can also be used as appropriate. For example the cost function could also be derived using scaled integers as opposed to scaled vectors. In FIG. 5, the cost functions are shown at 504 and 507. The skilled person would understand that while cost functions can be calculated for the current estimate of the vector, b and the two mutated estimates of the vector, b at the same time, the costs functions may also be calculated separately. For example, the cost function for the current estimate of the vector, b, may be calculated before the copying/cloning and mutation steps. In addition, in some examples the cost function of the current estimate of the vector, b, may be imported from a previous iteration rather than calculated as part of this iteration.

As shown in FIG. 5, steps 422 to 426 can form part of process B which is known as fission. In this regard, the above steps can be considered part of a genetic evolution to find an estimate of the vector, b and the current estimate of the vector, b can be considered a parent cell. During fission, two copies of the parent cell's genome are produced under the influence of mutation. Similar to biological mutation, the mutation vector is randomly generated and results in the genomes of a pair of daughter cells.

The cost functions 504 and 507, can now be used to select a new current estimate of the vector, b as part of selection process C from FIG. 5. To this end, as shown in 510 of FIG. 5, the cost functions for the current estimate of the vector, b and the mutated estimates of the vector b are compared. In terms of method 400, at step 428 the estimate of the vector, b that has the best value of the cost function is selected. The selection is made from the current estimate of the vector, b and the two mutated estimates of the vector, b. In some examples, the best value of the cost function is the lowest value of the cost function. However, the skilled person would understand that cost functions may be formed where the best value of the cost function is the highest value of the cost function. The best value of the cost function is therefore the value of the cost function that indicates the vector, b, comes closest to minimizing the square of the norm of the application of the inverse channel matrix to the sum of the vector representing the signal and the estimate of the vector, b.

At step 430 and 540, the current estimate of the vector, b, is updated to be the estimate of the vector, b, with the best value of the cost function. In more detail, if one of the mutated copies of the vector, b, has the best value of the cost function, then the former current estimate of the vector, b, is replaced with the mutated copy of the vector, b that had the best value of the cost function. If the current estimate of the vector, b has the best value of the cost function then this current estimate of the vector, b is maintained as the current estimate of the vector, b. If both one (or both) of the mutated copies of the vector, b and the current estimate of the vector, b, have the same best value of the cost function then the current estimate of the vector, b, is maintained as the current estimate of the vector, b. If both of the mutated copies of the vector, b have the same best value of the cost function (and the current estimate of the vector, b, has a worse value of the cost function) then one of the mutated copies of the vector, b, may be selected at random to be the new current estimate of the vector, b. In other examples, if both of the mutated copies of the vector, b, have the same best value of the cost function (and the current estimate of the vector, b, has a worse value of the cost function) then the first generated mutated copy can be used as the new current estimate of the vector, b.

As shown in FIG. 5, in selection step C, the current estimate of the vector, b is updated with a new estimate 511 l_{g+1} and the cost function for this estimate is given by γ̅(l_{g+1}) at 514. The processes of finding a precoding in the form of vector, b can then move on to the adaption steps shown in step D of FIG. 5.

At step 432, of FIG. 4 and 515 of FIG. 5, the best value of the cost function for this iteration is compared with the best value of the cost function from the iteration immediately previous to the current iteration e.g. the best value of the cost function from the previous iteration.

As shown in 521, and described in step 434, if the best value of the cost function from this iteration is the same as the best value of the cost function from the previous iteration, then the counter for the processing run is incremented. In one example incrementing the counter involves increasing the counter, for example the counter may be a counter that counts up from an initial value to a threshold value in increments of one. However, in other examples, the counter may also count down from an initial value to a threshold value. In addition, the counter may increment (either increase or decrease) by increments other than one.

As shown in 531, and described in step 436, the best value of the cost function is better than the best value of the cost function from a previous iteration, the counter for the processing run is reset to its initial value. As described previously, in some examples a value of the cost function is better than another value of the cost function when it is lower than the other value of the cost function. However, the skilled person would understand that cost functions can be selected where a value of the cost function is better than another value of the cost function when it is higher than the other value of the cost function depending upon the form of the cost function.

While the method described above, selects the estimate of the vector b that has the best value of the cost function and compares the best value of the cost function between cycles separately, in other examples these can be combined in a single step. In such an example, if the current estimate of the vector b has the best value of the cost function, the best value of the cost function is assumed to remain the same between iterations and the value of the counter is incremented. In contrast, if one of the mutated copies of the vector b has the best value of the cost function, the best value of the cost function is assumed to have changed between iterations and the counter is reset. In some example, this assumption can be strengthened by having the selection choose the current estimate of the vector b if both the current estimate of the vector b and one or more of the mutated copies of the vector b have the same best cost function. In another example, the best value of the cost function from the current estimate of the vector b and the two mutated copies of the vector b is selected for the current iteration. This is then compared to the best value of the cost function from the previous iteration and the current estimate of vector b is only updated if the best value of the cost function improves between iterations. In this example, the value of the counter is incremented or reset as described above.

At step 438 and 524, the value of the counter is compared to the threshold value. If as shown in 446 and 526, the counter has not reached the threshold value, then the iteration steps can be repeated. As such, the method in FIG. 4 can return to step 422 of the method. As mentioned above, in some examples the counter can increase in unit increments from the initial value to the threshold value. In other examples, the counter can decrease in unit increments from the initial value to the threshold value. In other examples, the increments may be larger or smaller than a unit increment. The threshold value of the counter may depend upon the size of the inverse channel matrix. In some examples where the counter increases in unit increments the threshold value may be 20 for K=L=30 and an initial value of 0 although other threshold values are possible depending on how close to an optimal answer is desired.

It is noted that if the counter is reset in steps 432 and 436 then step 438 may not be performed since the counter has been reset and thus has not reached the threshold value. Therefore, the comparison of the counter to the threshold value in step 438 can be skipped and the iteration steps can be repeated after the reset of the counter in step 436. However, in other examples, the comparison step 438 may occur in all cases even if the counter has been reset.

If in step 438 and 524, the counter has reached the threshold value then at step 440 and 528, a processing run estimate of the vector b is returned from the processing run. The iteration steps for that processing run therefore end. If there are multiple processing runs, then the end of one processing run may not impact other processing runs and the other processing runs may continue until they return their own processing run estimate of the vector b. In other examples, when one processing run finishes, all processing runs may terminate and provide their current best estimate of the vector, b as a processing run estimate of the vector b. This can reduce processing delays. In yet further examples, the method may wait for m of the n processing runs to reach the end before terminating all remaining processing runs. This provides a trade-off between processing delays and having an increased probability of finding a near optimal solution for the vector, b.

When each processing run acted on an initial estimate of the vector, b in the reduced basis (e.g. lᵣₒ) then the method may comprise returning the estimates to the original basis before performing the next step. In this regard the processing run estimate of the vector b in the reduced basis may be lₚ and in the original basis may be bₚ. The processing run estimate in the reduced basis may be returned to the original basis via the transform bₚ=Tbₚ.

In step 442, a cost estimate for each processing run estimate of the vector b is obtained. In some examples, the cost estimates for each processing run estimate of the vector b may be recalculated at this stage. However, in other examples, for example where the processing run estimate of the vector b does not undergo a basis change before this stage of processing, the cost estimates may be obtained from the cost estimates obtained during the processing run stages. Therefore, the cost estimates may be stored with the processing run estimates of the vector b and obtained in this way. The cost function may be chosen based on the current basis (e.g. reduced or original) of the processing run estimates of the vector b.

In step 444, a value for vector b is chosen where the value for vector b is chosen to be the processing run estimate of the vector b with the best value of the cost function. As described earlier, the best value of the cost function may be the lowest value of the cost function. However, in other examples, the cost function may be chosen such that a higher value indicates a lower cost. In this case, the best value of the cost function may be the highest value of the cost function. The best value of the cost function therefore represents the processing run estimate of the vector b that most accurately/effectively minimizes a square of a norm of a result of applying the inverse channel matrix G to the sum of the vector representing the signal, u, and the vector, b.

As described above, once vector b has been determined, it can be used as a precoding for beamforming. To this end, the vector b can be added to the signal u to form pre-coded signal u. If the vector b was found in the reduced basis and has not yet been converted back to the original basis, the vector may be transformed back to the original basis before being added to the signal e.g. b_{f}=Tl_{f} where b_{f} is the final estimate of the vector b and l_{f} is the final estimate of the vector b in the reduced basis. The inverse channel matrix can then be applied to the pre-coded signal u to obtain a corrected signal x. The corrected signal can then be transmitted through the wireless channel.

Transmitting the corrected signal, x through the wireless channel results in the application of the channel matrix to the corrected signal. In addition, the signal may acquire noise which can be modelled as a vector, n. This results in the receiver receiving signal in the form of vector y where

$$y = ( \begin{matrix}{y}_{1} \\ {y}_{2} \\ ⋯ \\ {y}_{k}\end{matrix} ) .$$

When precoding is used, the receiver may process the signal to remove the precoding. Given the precoding vector b has integer values and the signal vector, u, has entries in the interval, [−½,½] it is possible to use a modulo operator to obtain an estimate of the signal vector, u from the received signal, y. An output signal z can thus be obtained using

$$z = [ \begin{matrix}{y}_{1} - ⌊ {y}_{1} + 0.5 ⌋ \\ {y}_{2} - ⌊ {y}_{2} + 0.5 ⌋ \\ ⋯ \\ {y}_{k} - ⌊ {y}_{k} + 0.5 ⌋\end{matrix} ] .$$

Under the assumption of a noiseless channel and GH=I where I is the identity matrix then z=u.

It is noted that while the vector b is chosen to minimize the amplification applied by inverse channel matrix G, in some examples, inverse channel matrix, G, may still apply an amplification to the signal. In these examples it may still be necessary to divide the signal x by a factor before transmission and multiply the received signal y by a signal after transmission. However, the use of precoding in the form of vector b should reduce the size of the factor and hence reduce the amplification of any noise from the channel.

The above has described a computational more efficient way to obtain a more accurate estimate of the vector, b used for precoding. In some examples, this process can be improved even further by varying the probability of the mutation vectors applying a mutation to a copy of the current estimate of the vector b. As discussed above, the mutation vector can be applied to the copy of the current estimate of the vector, b by adding the mutation vector to the copy of the current estimate of the vector, b. The mutation vector can have elements −1, 0 or 1 wherein an element of −1 or 1 applies a mutation to the copy of the current estimate of the vector, b and an element 0 does not apply a mutation to the copy of the current estimate of the vector, b. Upon generation, each element of a mutation vector can have a probability, p, of applying a mutation to a copy of the current estimate of the vector, b. In other words, an element of a mutation vector can have a probability p of being either −1 or 1. The probability of the element being −1 and 1 can be equal. Thus, the element of the mutation vector can have a probability p/2 of being −1, a probability p/2 of being 1 and a probability 1-p of being 0.

In some examples, all elements of the mutation vector are equally susceptible to applying a mutation (e.g. to be −1 or 1) and the probability of the element applying a mutation remains constant, independently of the value of the counter. In some examples this probability, p, may be between 0.5 and 0.6 although other values of p may also be used.

In other examples, the probability of an element of a mutation vector applying a mutation varies between iterations. In these examples, the mutation vectors are generated such that initially (e.g. in the first iteration) all elements of the mutation vector are susceptible to applying a mutation to the copy of the current estimate of the vector b (e.g. are susceptible to having a value −1 or 1) and apply a mutation to the copy of the current estimate of the vector, b with the same probability e.g. P (e.g. have a probability P of having a value −1 or 1). Here initially refers to the mutation vectors generated/used in the first iteration, e.g. the iteration that operates on the initial estimate of the vector, b, e.g., the iteration that occurs when the counter is set to the initial value for the first time.

If the results of the first iteration are that a mutated copy of the vector, b has a best value of the cost function then the original susceptibilities to mutation and probabilities of mutation are kept when generating mutation vectors for the next iteration e.g. the iteration subsequent to the first/current iteration.

In contrast, if the mutated copies of the vector, b do not improve the best value of the cost function compared to the current estimate of the vector, b then the probabilities and susceptibilities are adjusted when generating mutation vectors for the next iteration. In particular, when generating mutation vectors for the next iteration, the number of elements of the vector b that are susceptible to mutation are decreased and the probability of each susceptible element applying a mutation is increased. While this is described with respect to the first iteration, such a process occurs for each iteration.

In other words, for each iteration if the best value of the cost function is the same as the best value of the cost function from the previous iteration, then the mutation vectors generated in the next iteration have fewer elements susceptible to applying a mutation (e.g. which can take a value of −1 or 1 as well as 0) but the probability of each susceptible element applying a mutation is increased (e.g. the probability of the value being −1 or 1 rather than 0 is increased for the susceptible elements). In contrast, in response to the best value of the cost function for the current iteration being better than the best value of the cost function from the previous iteration, the random mutation vectors in the next iteration are generated using the same susceptibilities and probabilities as the mutation vectors from the current iteration.

In one example, the changes in susceptibility and probability can depend upon the threshold value of the counter. In particular, in the initial or first iteration, each of the K elements of the mutation vector can be susceptible to applying a mutation with a probability P. In some examples, P may be between 0.5 and 0.6. However, other values of P may be suitable. As mentioned previously, K is the number of antenna and the number of elements in the vectors. As such, the number of elements susceptible to applying a mutation, N is N⁽¹⁾=K and the probability of each element applying a mutation is P⁽¹⁾=P where the superscript (1) represents the initial parameters under which the mutation vectors are generated.

If it the first iteration, the best value of the cost function is the same as the value of the cost function for the current estimate of the vector, b, (e.g. the initial estimate of the vector b since this is the first iteration) then in the next iteration the mutation vectors are generated such that the number of elements susceptible to applying a mutation is given by

$${N}^{( 2 )} = ⌈ {N}^{( 1 )} \sqrt[R]{1 / K} ⌉$$

and the probability of applying a mutation is given by

$${P}^{( 2 )} = {P}^{( 1 )} \sqrt[R]{1 / {P}^{( 1 )}} .$$

In the case where the counter increases in units of 1, the minimum value of the counter is gᵢₙₜ and the threshold value of the counter is gₘₐₓ then and

$$R = \frac{{g}_{max} - {g}_{int}}{2} .$$

If the counter is instead increased by units of f then and

$$R = \frac{{g}_{max} - {g}_{int}}{2 f} .$$

Similarly, if the counter decreases from gᵢₙₜ to a threshold of gₜₕᵣ in units of f then

$$R = \frac{{g}_{int} - {g}_{thr}}{2 f} .$$

The process of changing the susceptibility to performing a mutation and probability of performing a mutation repeats for further iterations. Thus, if the best value of the cost function remains the same between a current iteration and a previous iteration (or the initial value of the cost function in the case of the current iteration being the first iteration) the parameters used to generate the mutation vectors are updated in the next iteration such that

$${N}^{( n )} = ⌈ {N}^{( p )} \sqrt[R]{1 / K} ⌉$$

$$and$$

$${P}^{( n )} = {P}^{( p )} \sqrt[R]{1 / {P}^{( p )}}$$

where superscript (n) represents the new parameters and superscript (p) the parameters of the current iteration. This can also be represented as

$${P}_{n} = {P}_{p} \sqrt[R]{\frac{1}{{P}_{p}}}$$

wherein Pₚ is the probability of each susceptible element of the mutation applying a mutation in the current iteration and

$${N}_{n} = {N}_{p} \sqrt[R]{\frac{1}{K}}$$

wherein Nₚ is the number of elements susceptible to mutation in the current iteration. In contrast, if the best value of the cost function in a current iteration is updated from the previous iteration (or the initial value of the cost function in the case of the current iteration being the first iteration) then the mutation parameters remain the same in the next iteration. The previous iteration can be the immediate previous iteration e.g. the iteration before the current iteration.

Changing the parameters used to generate the mutation vectors represent a form of annealing which can lead to an improved probability of the iterative process returning an accurate result in the iterative process finding a suitable estimate for the precoding vector, b, more efficiently.

In one detailed example, a computer-implemented method for determining a transmit precoding operation to apply to a signal to be transmitted through a wireless channel via beamforming wherein the signal is represented by a vector, u, is provided. The method comprises obtaining an inverse channel matrix, G wherein the inverse channel matrix, G, is an inverse of a channel matrix, H, wherein the channel matrix, H, is a matrix representation of the wireless channel. If the channel matrix, H, is square then the inverse channel matrix, G can be determined in any known way. If the channel matrix, G, is rectangular, then a Moore-Penrose pseudo inverse can be used to find the inverse channel matrix, G. The method further comprises determining a vector, b, that approximately minimizes a square of a norm of a result of applying the inverse channel matrix G to the sum of the vector representing the signal, u, and the vector, b, wherein the entries of the vector, b, are integers. Determining the vector b, comprises obtaining an initial estimate for the vector, b. As described above, this can be done using a unimodular transform, T, obtained from lattice reduction wherein the initial estimate of the vector b, bᵣₒ, is given by bᵣₒ=−T [T⁻¹u]. The below processing can then be done on the vector b in a reduced lattice basis wherein l=T⁻¹b where I is the estimate of the vector b in the reduced basis and b is the estimate of the vector b in the original basis. If T is a square matrix, then the inverse of T, T⁻¹, can be calculated in any known way. When T is a rectangular matrix, then a Moore-Penrose pseudo inverse can be used to calculate the inverse of T. The method further comprises cloning the initial estimate of the vector, b, n times, and providing a clone of the initial estimate of the vector b to each of n independent processing runs as a current estimate for the vector, b. Determining the vector, b then comprises for each of the n independent processing runs, setting a counter to an initial value, and then iteratively producing two copies of the current estimate for the vector, b, applying a randomly generated mutation vector to each of the two copies of the current estimate of the vector, b, wherein the randomly generated mutation vector is generated separately for each copy of the current estimate of the vector, b, calculating a value of a cost function for the current estimate of the vector, b, and the two mutated copies of the current estimate of the vector, b, selecting the estimate of the vector b that has the lowest value of the cost function wherein the selection is from the two mutated copies of the current estimate of the vector, b, and the current estimate of the vector b; and in response to the selected estimate being one of the mutated copies of the current estimate of the vector, b, replacing the current estimate of the vector, b, with the mutated copy of the current estimate of the vector, b, that resulted in the lowest value of the cost function, and resetting the counter to the initial value, or in response to the selected estimate being the current estimate of the vector, b, maintaining the current estimate of the vector, b, and increasing the value of the counter. The iterative process them comprises determining if the counter has reached a threshold value, and in response to the counter not having reached the threshold value performing another iteration of the above steps, or in response to the counter having reached the threshold value, returning the current estimate of the vector, b, as the processing run estimate of the vector b. Once the processing runs have returned a processing run estimate of the vector b the method further comprises obtaining a value of the cost function for each processing run estimate of the vector, b; and selecting as the vector, b, the processing run estimate of the vector b with the lowest value of the cost function. If the initial estimate of the vector b was determined using a unimodular transform then the vector, b, can be transformed back to the original basis using the transform b=Tl where b is the estimate of the vector b in the original basis and l is the estimate of the vector b in the reduced basis obtained through the unimodular transform.

In summary, a method is provided of finding an improved precoding in the form of a vector, b for multi-input, multi-output beamforming. In particular, the method aids in selecting a precoding vector, b used in beamforming to reduce the amount of amplification that is applied to a signal when the signal is multiplied by the inverse channel matrix. This reduces the degree to which the signal needs to be reduced (or de-amplified) before it is sent through a channel. This is turn reduces the degree to which the signal needs to be amplified at the other end of the channel and hence reduces the amplification of any noise gained in the channel. The techniques discussed above strike a better complexity-performance trade-off than start-of the-art architectures in that they have a lower complexity best-case, converge faster than classic Schnorr-Euchner methods and have a higher asymptotic memory efficiency than known techniques where the memory size tends to infinity.

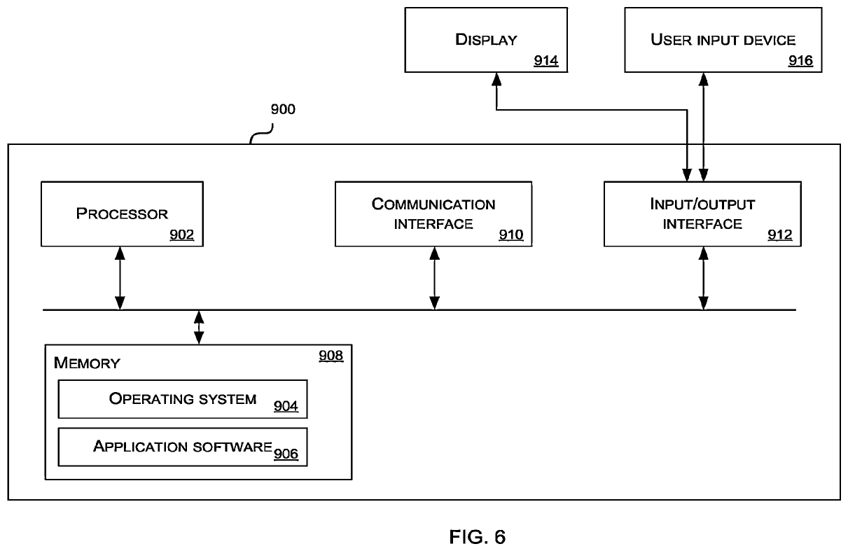

FIG. 6 illustrates various components of an exemplary computing-based device 900 which may be implemented as any form of a computing and/or electronic device, and in which embodiments of the above method may be implemented.

Computing-based device 900 comprises one or more processors 902 which may be microprocessors, controllers or any other suitable type of processors for processing computer executable instructions to control the operation of the device in order to determine the transmit precoding operation. In some examples, for example where a system on a chip architecture is used, the processors 900 may include one or more fixed function blocks (also referred to as accelerators) which implement a part of the method of determining the transmit precoding in hardware (rather than software or firmware). Platform software comprising an operating system 904 or any other suitable platform software may be provided at the computing-based device to enable application software 906 to be executed on the device.

The computer executable instructions may be provided using any computer-readable media that is accessible by computing based device 900. Computer-readable media may include, for example, computer storage media such as memory 908 and communications media. Computer storage media, such as memory 908, includes volatile and non-volatile, removable and non-removable media implemented in any method or technology for storage of information such as computer readable instructions, data structures, program modules or other data. Computer storage media includes, but is not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer readable instructions, data structures, program modules, or other data in a modulated data signal, such as a carrier wave, or other transport mechanism. As defined herein, computer storage media does not include communication media. Although the computer storage media (memory 908) is shown within the computing-based device 900 it will be appreciated that the storage may be distributed or located remotely and accessed via a network or other communication link (e.g. using communication interface 910).

The computing-based device 900 also comprises an input/output interface 912 arranged to output display information to a display device 914 which may be separate from or integral to the computing-based device 900. The display information may provide a graphical user interface. The input/output interface 912 is also arranged to receive and process input from one or more devices, such as a user input device 916 (e.g. a mouse, a keyboard or a microphone etc.). This user input may be used to receive input data, for example, signal, u. In an embodiment the display device 914 may also act as the user input device 916 if it is a touch sensitive display device. The input/output interface 912 may also output data to devices other than the display device, e.g. a locally connected printing device (not shown in FIG. 6).

The term ‘computer’ is used herein to refer to any device with processing capability such that it can execute instructions. Those skilled in the art will realize that such processing capabilities are incorporated into many different devices and therefore the term ‘computer’ includes PCs, servers, mobile telephones, personal digital assistants and many other devices.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

Any range or device value given herein may be extended or altered without losing the effect sought, as will be apparent to the skilled person.

It will be understood that the benefits and advantages described above may relate to one embodiment or may relate to several embodiments. The embodiments are not limited to those that solve any or all of the stated problems or those that have any or all of the stated benefits and advantages.

Any reference to ‘an’ item refers to one or more of those items. The term ‘comprising’ is used herein to mean including the method blocks or elements identified, but that such blocks or elements do not comprise an exclusive list and an apparatus may contain additional blocks or elements and a method may contain additional operations or elements. Furthermore, the blocks, elements and operations are themselves not impliedly closed.

The steps of the methods described herein may be carried out in any suitable order, or simultaneously where appropriate. The arrows between boxes in the figures show one example sequence of method steps but are not intended to exclude other sequences or the performance of multiple steps in parallel. Additionally, individual blocks may be deleted from any of the methods without departing from the spirit and scope of the subject matter described herein. Aspects of any of the examples described above may be combined with aspects of any of the other examples described to form further examples without losing the effect sought. Where elements of the figures are shown connected by arrows, it will be appreciated that these arrows show just one example flow of communications (including data and control messages) between elements. The flow between elements may be in either direction or in both directions.

It will be understood that the above description of a preferred embodiment is given by way of example only and that various modifications may be made by those skilled in the art. Although various embodiments have been described above with a certain degree of particularity, or with reference to one or more individual embodiments, those skilled in the art could make numerous alterations to the disclosed embodiments without departing from the spirit or scope of this invention.

Where the description has explicitly disclosed in isolation some individual features, any apparent combination of two or more such features is considered also to be disclosed, to the extent that such features or combinations are apparent and capable of being carried out based on the present specification as a whole in the light of the common general knowledge of a person skilled in the art, irrespective of whether such features or combinations of features solve any problems disclosed herein. In view of the foregoing description it will be evident to a person skilled in the art that various modifications may be made within the scope of the invention.

1. A computer-implemented method for determining a transmit precoding operation to apply to a signal to be transmitted through a wireless channel via beamforming wherein the signal u is represented by a vector, u, and the method comprises:
obtaining an inverse channel matrix, G wherein the inverse channel matrix, G, is an inverse of a channel matrix, H, wherein the channel matrix, H, is a matrix representation of the wireless channel;
determining a vector, b, that approximately minimizes a square of a norm of a result of applying the inverse channel matrix G to the sum of the vector representing the signal, u, and the vector, b, wherein the entries of the vector, b, are integers and determining the vector b, comprises:
obtaining an initial estimate for the vector, b;
cloning the initial estimate of the vector, b, n times;
providing a clone of the initial estimate of the vector b to each of n independent processing runs as a current estimate for the vector, b; and
for each of the n independent processing runs, setting a counter to an initial value, and then iteratively performing the following iteration steps:
producing two copies of the current estimate for the vector, b;
applying a randomly generated mutation vector to each of the two copies of the current estimate of the vector, b, wherein the randomly generated mutation vector is generated separately for each copy of the current estimate of the vector, b;
calculating a value of a cost function for the current estimate of the vector, b, and the two mutated copies of the current estimate of the vector, b;
selecting the estimate of the vector b that has a best value of the cost function wherein the selection is from the two mutated copies of the current estimate of the vector, b, and the current estimate of the vector b; and
in response to the selected estimate being one of the mutated copies of the current estimate of the vector, b, replacing the current estimate of the vector, b, with the mutated copy of the current estimate of the vector, b, that resulted in the best value of the cost function;
in response to the selected estimate being the current estimate of the vector, b, maintaining the current estimate of the vector, b;
comparing the best value of the cost function with a best value of the cost function from the previous iteration; and
in response to the best value of the cost function being better than the best value of the cost function from the previous iteration:
resetting the counter to the initial value; and
performing another iteration of the iteration steps;
in response to the best value of the cost function being the same as the best value of the cost function from the previous iteration:
incrementing the value of the counter;
determining if the counter has reached a threshold value; and
in response to the counter not having reached the threshold value performing another iteration of the iteration steps; and
in response to the counter having reached the threshold value, returning the current estimate of the vector, b, as the processing run estimate of the vector b;
once at least one of the processing runs has returned a processing run estimate of the vector b;
obtaining a value of the cost function for each processing run estimate of the vector, b; and
selecting as the vector, b, the processing run estimate of the vector b with the best value of the cost function.

2. The method of claim 1 further comprising:
applying the transmit precoding operation to the signal by adding the vector b to the vector representation of the signal, u, to obtain a pre-coded signal;
applying the inverse channel matrix, G, to the pre-coded signal to obtain a corrected signal; and
transmitting the corrected signal through the wireless channel.

3. The method of claim 2 further comprising:
receiving the transmitted corrected signal;
applying a modulo function to each entry of the vector representing the transmitted corrected signal wherein the modulo function keeps both the sign and fractional part of its input value.

4. The method of claim 1 wherein determining a vector, b, that approximately minimizes the square of the norm of the value obtained when applying the inverse channel matrix G to the sum of the vector representing the signal, u, and the vector, b, comprises determining a vector, b, that approximately minimizes the function ∥−Gu−Gb∥².

5. The method of claim 1 wherein the cost function comprises a square of a norm of a result of applying the inverse channel matrix G to the sum of the vector representation of the signal, u, and the estimate of the vector, b.

6. The method of claim 1 wherein obtaining an initial estimate of the vector, b, comprises:
performing lattice reduction on the inverse channel matrix, G, to obtain a reduced inverse channel matrix G₁ and a unimodular transformation T;
obtaining an initial estimate of the vector, b, using Babai's rounding off technique and the unimodular transformation, T; and
transforming the obtained initial estimate of the vector, b, into the reduced lattice basis.

7. The method of claim 6 wherein performing lattice reduction on the inverse channel matrix, G comprises using a Lenstra-Lenstra-Lovász algorithm to obtain the reduced inverse channel matrix Gₗ and the unimodular transformation T.

8. The method of claim 6 wherein the cost function comprises ∥G(u+Tlₑ)∥² for an estimate of the vector, b, in the reduced lattice basis wherein the estimate of the vector, b, in the reduced lattice is given as lₑ.

9. The method of claim 1 further comprising:
in response to the current estimate of the vector, b, and at least one of the two mutated copies of the estimate of the vector, b, both having the best value of the cost function selecting the current estimate of the vector, b, as having the best value of the cost function.

10. The method of claim 1 further comprising:
in response to both of the mutated copies of the estimate of the vector, b, having the best value of the cost function randomly selecting one of the mutated copies as having the best value of the cost function.

11. The method of claim 1 further comprising:
for the first iteration randomly generating the mutation vectors such that all elements of each mutation vector are susceptible to applying a mutation to a copy of the current estimate of the vector, b, and each element of each mutation vector applies a mutation to the copy of the current estimate of the vector, b, with probability, P; and
in response to the best value of the cost function being the same as the best value of the cost function from the previous iteration:
decreasing the number of elements of the mutation vector that are susceptible to applying a mutation to a copy of the current estimate of the vector, b in the next iteration; and
increasing the probability of each susceptible element of the mutation vector applying a mutation to the copy of the current estimate of the vector, b in the next iteration.

12. The method of claim 11 further comprising:
in response to the best value of the cost function being better than the best value of the cost function from the previous iteration:
in the next iteration maintaining the number of elements of the mutation vector that are susceptible to applying a mutation as the number of elements of the mutation vector that were susceptible to applying a mutation in the current iteration; and
in the next iteration maintaining the probability of each susceptible element of the mutation vector applying a mutation as the probability of each susceptible element of the mutation vector applying a mutation from the current iteration.

13. The method of claim 11 wherein:
the initial value of the counter is gᵢₙₜ;
the threshold value of the counter is gₘₐₓ;
in response to the best value of the cost function being the same as the best value of the cost function from the previous iteration:
increasing the probability of each susceptible element of the mutation vector applying a mutation in the next iteration to
$${P}_{n} = {P}_{p} \sqrt[R]{\frac{1}{{P}_{p}}}$$
wherein Pₚ is the probability of each susceptible element of the mutation vector applying a mutation in the current iteration, and
$$R = \frac{{g}_{max} - {g}_{int}}{2} ;$$
and
decreasing the number of elements of the mutation vector that are susceptible to applying a mutation in the next iteration to
$${N}_{n} = {N}_{p} \sqrt[R]{\frac{1}{K}}$$
wherein Nₚ is the number of elements susceptible to applying a mutation in the current iteration and K is the number of elements of the mutation vector.

14. An apparatus for determining a transmit precoding operation to apply to a signal be transmitted through a wireless channel via beamforming wherein the signal u is represented by a vector, u, the apparatus comprising:
a processor; and
a memory, the memory containing computer-readable instructions that when executed by the processor cause the processor to perform a method according to claim 1.

15. A non-transitory computer-readable storage medium containing computer-readable instructions that when executed by the processor cause the processor to perform a method according to claim 1.
